(19) United States
(12) Patent Application Publication
(10) Pub. No.: US 2008/0204258 A1
(43) Pub. Date: Aug. 28, 2008

(54) MOTION-, LIGHT-, AND WIRELESS-TRIGGERED LIGHTS AND AUDIO ALARMS

(76) Inventors: Douglas C. Dayton, Harvard, MA (US); Mark R. Florence, Newton, MA (US); Sung Park, Newton, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/029,687

(22) Filed: Feb. 12, 2008

Related U.S. Application Data
(60) Provisional application No. 60/901,215, filed on Feb. 12, 2007.
(60) Provisional application No. 60/979,813, filed on Oct. 13, 2007.
(60) Provisional application No. 60/990,748, filed on Nov. 28, 2007.
(60) Provisional application No. 61/016,673, filed on Dec. 26, 2007.

(51) Int. Cl. G08B 21/02

(52) U.S. Cl. 340/600; 340/384.1; 340/825

(57) ABSTRACT

In embodiments of the present invention, systems and methods for navigating in low light may comprise providing a light integrated in an object, associating the light with a power source, associating the light with a motion- and light-sensitive trigger, and powering the light when the motion-trigger senses motion and the light-trigger senses low light.

### CROSS-REFERENCE TO RELATED APPLICATIONS

This application claims the benefit of the following provisional applications, each of which is hereby incorporated by reference in its entirety: U.S. Provisional Application No. 60/901,215 filed Feb. 12, 2007; U.S. Provisional Application No. 60/979,813 filed Oct. 13, 2007; U.S. Provisional Application No. 60/990,748 filed Nov. 28, 2007; and U.S. Provisional Application No. 61/016,673 filed Dec. 26, 2007.

### BACKGROUND

1. Field

The methods and systems described herein relate to motion-sensitive, light-sensitive night lights and audio alarms.

2. Description of the Related Art

Navigation around an area in the dark is often difficult due to unseen obstacles. Motion-, light-, and wirelessly-triggered night lights and audio alarms assist those attempting to navigate in the dark in a hands free manner.

### SUMMARY

Provided herein are methods and systems for navigation under low light situations. A method and system for navigating in low light may comprise providing a light source integrated in an object, associating the light source with a power source, associating the light source with a motion- and light-sensitive trigger, and powering the light source when the motion-trigger senses motion and the light-trigger senses low light. The method and system may further comprise powering an additional light when the first light is triggered. In the method and system, the object may be a household object, a baseboard, a bath mat, a stand-alone light, furniture, stairs, and a light bulb adaptor. In the method and system, the motion- and light-sensitive trigger may be housed in a light bulb adaptor. In another method and system the motion- and light-sensitive trigger may be housed in an alarm clock.

A method and system for navigating in low light may comprise providing a lighting system distributed about an area, associating the lighting system with a power source, associating the power source with a controller, wherein the controller controls at least a portion of the lighting system, and using the controller to activate at least a portion of the lighting system corresponding to the portion of the area to be navigated. In the method and system, the lighting system may be active. In the method and system, the lighting system may be passive.

A method and system of navigating in low light may comprise providing an audible tone generator, associating the tone generator with a power source, associating the tone generator with a motion- and light-sensitive trigger, and powering the tone generator when the motion-trigger senses motion and the light-trigger senses low light.

A method and system of navigating in low light may comprise a motion- and/or light sensitive trigger for sensing a motion, a light source for providing illumination to the system, and a power source, the power source being associated with the light source, wherein the power source powers the light source when the trigger senses the motion. In an embodiment, the system of navigating in low light may be an alarm clock.

In an aspect of the invention, a method and system for navigating in low light may comprise providing a light source integrated with a household object, associating the light source with a power source, associating the light source with a motion- and light-sensitive trigger, and powering the light source when the motion-trigger senses motion and the light-trigger senses low light. The system and method may include powering an additional light when the light-trigger senses motion and low light. In the system and method, the household object may be at least one of a baseboard, a bath mat, an item of furniture, a stair, a picture frame, a door frame, a door knob, a clock, a railing, a passage, an edge of a bed, a rug, a bedside table, a planter, a plant, a mirror frame, a medicine cabinet, a towel rod, a shower rod, and a light bulb adaptor. The object may be constructed as an electroluminescent panel. In the system and method, the motion- and light-sensitive trigger may be housed in a light bulb adaptor configured to integrate a light bulb with the household object.

In an aspect of the invention, a system and method for navigating in low light may comprise providing a lighting system distributed about the perimeter of a household area in a position proximal to a baseboard of a room, associating the lighting system with a power source, associating the power source with a controller, wherein the controller controls at least a portion of the lighting system, and using the controller to activate at least a portion of the lighting system corresponding to the portion of the area to be navigated. In the system and method, the lighting system may be active or passive. In the system and method, the lighting system may be a fiber optic cabling. In the system and method, the lighting system may be associated with a sensor. The sensor may be an acoustic sensor or a light sensor. In the system and method, the lighting system may be disposed on the baseboard of a room. In the system and method, the controller may be at least one of a wireless controller, a corded controller, and a combination thereof. In the system and method, the lighting system may comprise a plurality of lights. Each of the plurality of lights may be controlled by the controller.

A method and system for navigating in low light may comprise providing a light source integrated with an electrical plug, associating the light source with a power source, associating the light source to a sensor, and powering the light source based on an impetus sensed by the sensor. The impetus may be a motion, proximity, radiation or low levels of light.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a motion- and light-sensitive baseboard lighting system;

FIG. 2 depicts a navigation lighting system-wireless control;

FIG. 3 depicts motion- and light-triggered night lights in everyday objects;

FIG. 4 depicts a light communication system;

FIG. 5 depicts an audio night alarm;

FIG. 6 depicts a light bulb adapter that creates a low-level night light from a standard bulb;

FIG. 7 depicts a battery powered motion activated nightlight;

FIG. 8 depicts a motion- and light-triggered alarm clock;

FIG. 9 depicts an exemplary small light being associated with a standard electrical outlet; and

FIG. 10 depicts an exemplary small light that is triggered by the motion.

### DETAILED DESCRIPTION

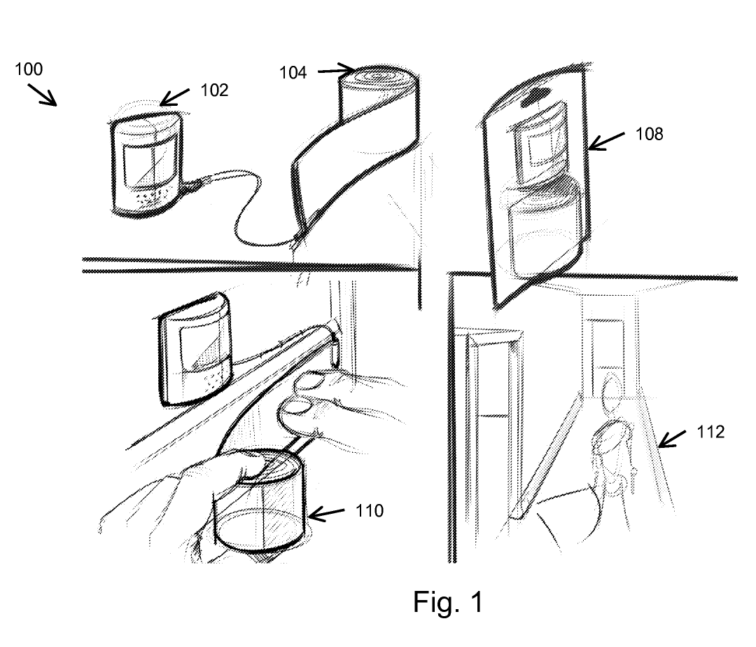

Referring to FIG. 1, motion- and light-sensitive lighting may enable navigation of an individual in low light. For example, a continuous baseboard night light system may softly light the entire length of the walkway and may easily be installed by a user as a roll of electroluminescent self adhesive material triggered by a motion detector 102. Motion-sensitive lighting may be automatically turned on when motion near the lighting is detected by a motion sensor and, optionally, if the ambient lighting level is low as detected by an associated light sensor. When the ambient light level is above a specified level so that it is possible to see without artificial light, the device may be inactive. In an aspect of the invention, the lighting may be distributed about an area that an individual may need to navigate during conditions of low light, such as along a hallway, a stairwell, a doorway, and the like. For example, the lighting may be distributed along a baseboard. In an embodiment, the lighting may be an LED light. The LED may be disposed on flex circuit substrate which may in turn be overlaid with a transparent or translucent lens material. For example, the overlay may be a continuous Fresnel lens that may provide diffusion for the LED's and may be bonded to the circuit so that the assembly may be thin and flexible. In another example, the lighting may be an electroluminescent panel. In another embodiment, lighting may be a single source illuminating fiber optic cabling throughout an area. In another embodiment, the lighting may be a light pipe molded as a strip with a large LED array at one end and diffusion lines all along the length of the pipe. In any event, any lighting may be associated with any power source. In an embodiment, the lighting may be electro-phosphorescent lighting. For example, the lighting may plug into an outlet, be battery-operated, be solar-powered, be generator-powered, and the like. In an embodiment, the lighting may be achieved using any lighting source. For example, the lighting source may be incandescent, fluorescent, halogen lighting, and the like.

In an aspect of the invention, the lighting may be associated with a motion- and light-sensitive sensor. The lighting may be powered when the motion-sensor senses motion. Alternatively, the trigger may be an acoustic trigger, sensing the presence of an individual acoustically. The motion trigger may be a sensor comprising infrared light or laser technology. When the sensor detects movement, a signal may be sent to a device, such as a light, an audible tone generator, and the like. The sensor may also detect cessation of movement or occupancy of an area and send a signal to the light or audible tone generator to extinguish the lighting or terminate the tone, respectively. The motion sensor may be coupled to a light sensor. For example, even if the motion detector 102 detects motion, no signal may be sent to a device if the light sensor detects light above a threshold level. Thus, the motion sensor may only trigger a device if the ambient light levels are low enough. In an embodiment, the light may not be controlled by a motion detector 102 and may be powered ON at all times. In an embodiment, adhesive baseboard lighting may be provided by a glow-in-the-dark appliqué or a passive lighting system, such as a reflective material. In an embodiment, the lighting may be achieved using any lighting source. For example, the lighting source may be incandescent, fluorescent, halogen lighting, and the like.

In an embodiment, a motion detector 102 may be connected to a flexible LED light 104. The motion detector 102 and LED light 104 may be packaged together for sale. The LED light 104 may be attached to a surface in an area where an individual may navigate in the dark. For example, the LED light 104 may have an adhesive backing 110 which may facilitate attaching the LED light 104 to a baseboard or part of the wall closest to the floor. The motion detector 102 may be mounted by any suitable attachment means, such as by an adhesive backing, a screw mount, suspension through a recess in back of the detector, and the like. When an individual passes the motion detector 102, the associated LED light 104 may illuminate a passage 112.

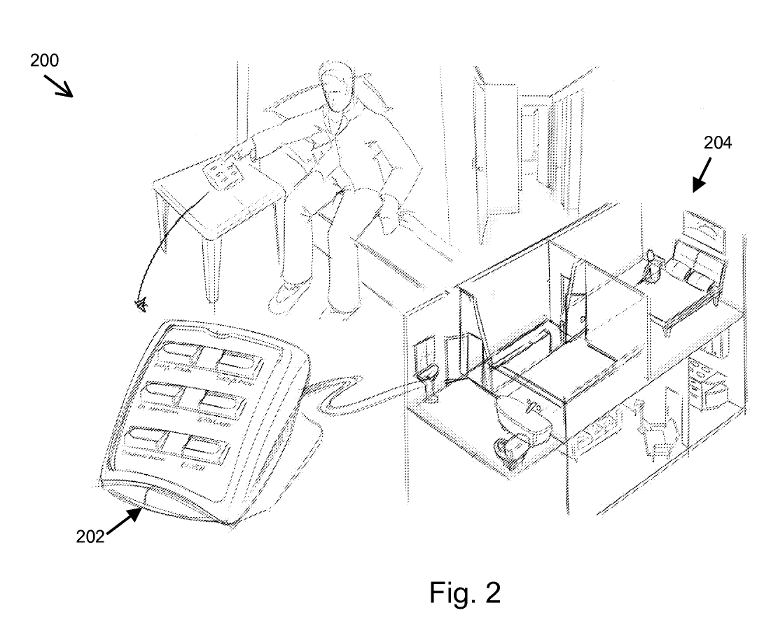

Referring to FIG. 2, in an aspect of the invention, the lighting may be associated with a controller 202. For example, a nighttime household navigation system may utilize wireless communication between a console and the baseboard nightlight system, wherein a console by the bedside triggers path-side illumination to normal nighttime destinations, e.g., bathroom, with multiple discrete paths defined throughout the house. In another example, a nighttime household navigation system may utilize wireless communication between the console and multiple discrete nightlights, such as those utilizing LED technology, wherein a console by the bedside triggers one or more discrete nightlights and/or a path-side illumination to normal nighttime destinations, e.g., bathroom, with multiple discrete paths defined throughout the house. The nightlights may be incandescent, fluorescent, halogen, and the like. In embodiments, the controller 202 may control both a baseboard nightlight system as well as discrete nightlights. The controller 202 may control any number of lights in a lighting system. For example, lighting, such as that described herein, may be distributed around an area, such as along all of the baseboards in a home, integrated in an object, free-standing on a surface, free-hanging on a wall, and the like, to form a lighting system. Each individual light or groups of lights may be controlled by a controller 202. The controller 202 may be a wireless remote control, a corded controller, or a combination thereof. The controller 202 may communicate with a range of lights throughout an area. The controller 202 may enable lighting to a particular destination from any current location by a controlling a light or set of lights between the current location and the destination. For example, the controller 202 may have buttons corresponding to individual lights or sets of lights which may turn on and off preset path 204 or plurality of preset path 204 of lights throughout an area or one light that communicates with the others to provide a lighted path 204 to a destination. For example, an individual may wish to go from their bedroom to the bathroom. The path 204 between the individual's bedroom and the bathroom may pass through a hallway before reaching the bathroom. Baseboard lighting, as described herein, may be distributed along the path 204. Other lighting, such as a night light integrated in a picture frame, a night light integrated in a bath mat, lighting along a door frame, along a railing, on a door knob, in a clock, and the like, may also be in the path 204 between the bedroom and the bathroom. The individual may use the controller 202 to control any lighting directly connected to the controller 202 or under wireless control by the controller 202 corresponding to the preset path 204, such as by pressing a button corresponding to the preset path 204. The controller 202 may automatically illuminate the lights under its control or it may activate motion- and or light-sensitive triggers connected to lights along the path 204 so that the sensors may trigger the light. The controller 202 may be used to turn on or off any lights or audible alarms in the entire area, along a preset path 204, along multiple path 204, in a single location, and the like. The controller 202 may be used to turn on or off any motion and/or light sensor in any lights or audible alarms in the entire area, along a preset path 204, along multiple path 204, in a single location, and the like.

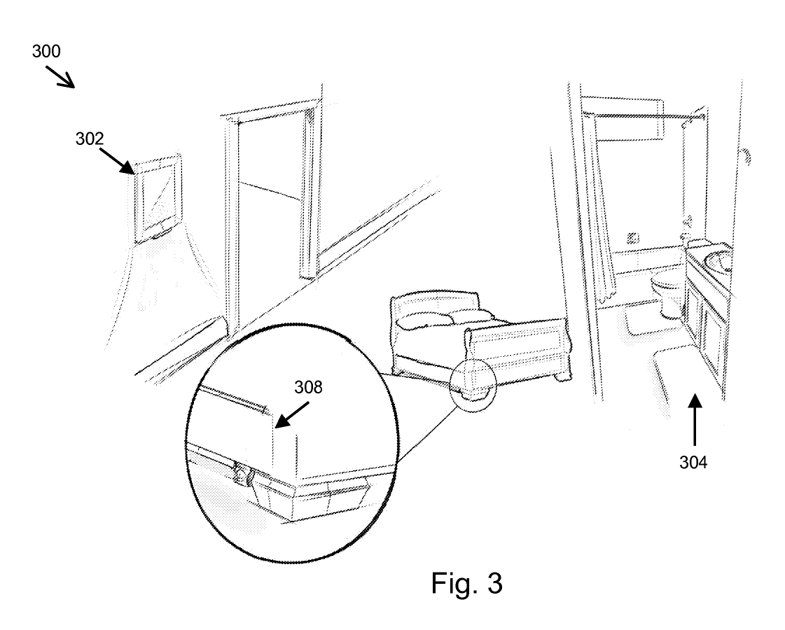

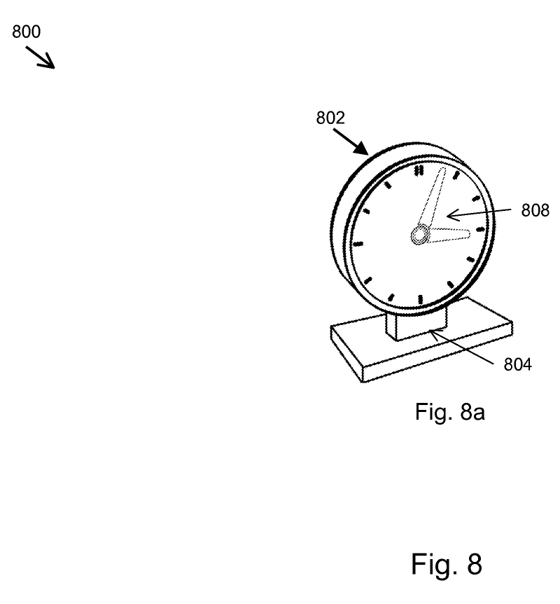

Referring to FIG. 3, motion-triggered night lights may be integrated into objects, such as under the edge of a bed 308, a bath mat 304, rugs, picture frame 302, the underside of bedside table, a planter, a plant, a mirror frame, medicine cabinet, towel rod, shower rod, a clock, and the like. A night light system utilizing a motion detector 102 and an ambient light sensor may reside in everyday objects such as a picture frame, a bath mat or the underside of a bed frame. A motion sensor may be disposed on, in, or near the object along with the lighting. The motion-activated night light may also comprise a light-sensitive trigger. In embodiments, the motion-sensitive trigger and/or light-sensitive trigger may be turned off so that the night light may be persistently on. Alternatively, the integrated lighting may be controlled by a controller 202. The controller 202 may automatically illuminate the light under its control or it may activate motion- and or light-sensitive sensors connected to the lights so that the sensors may trigger the light. In an embodiment, the motion-sensitive trigger inside an alarm clock 802 may be linked to a light source 808, as shown in FIG. 8. The motion-sensitive trigger on sensing a movement such as a hand movement may illuminate the light source 808 of the alarm clock 802. The illuminated alarm clock 802 may be used for navigation.

In an embodiment, a bath mat may be constructed as an electroluminescent panel with the bath mat tufting going right through the panel. In an alternative embodiment, a perimeter band of LEDs may encircle the bath mat. In yet another embodiment, the tufting may be fiber optic. In yet another embodiment, all of the elements of the aforementioned bath mat may be combined to form the motion-sensitive night light for a bath mat. In any event, a motion sensor may be disposed on the bath mat along with the lighting. Alternatively, the bath mat lighting may be controlled by a controller 202. The controller may automatically illuminate the lights under its control or it may activate motion- and or light-sensitive sensors connected to the lights so that the sensors may trigger the light. In an embodiment, the motion sensitive night light for the bath mat may be any light such as a LED, an incandescent, a fluorescent, a halogen night light, and the like.

In an embodiment, a picture frame 302 or frame of bed 308 may be constructed similar to the bath mat with an encircling of LEDs or a perimeter electroluminescent panel. In an alternative embodiment, the picture frame 302, frame of bed 308 may be translucent. By day, lights integrated into the frame may be obscured. A motion sensor controlling the lights may be disposed along the frame and directed towards an area where an individual may pass. In embodiments, the picture frame 302 or frame of bed 308 lighting may be controlled by a controller 202. The controller may automatically illuminate the picture frame 302, frame of bed 308 lights under its control or it may activate motion- and or light-sensitive sensors connected to the lights so that the sensors may trigger the light. In an embodiment, the lights integrated into the picture frame 302 may be any light such as LED, incandescent, fluorescent, halogen, and the like.

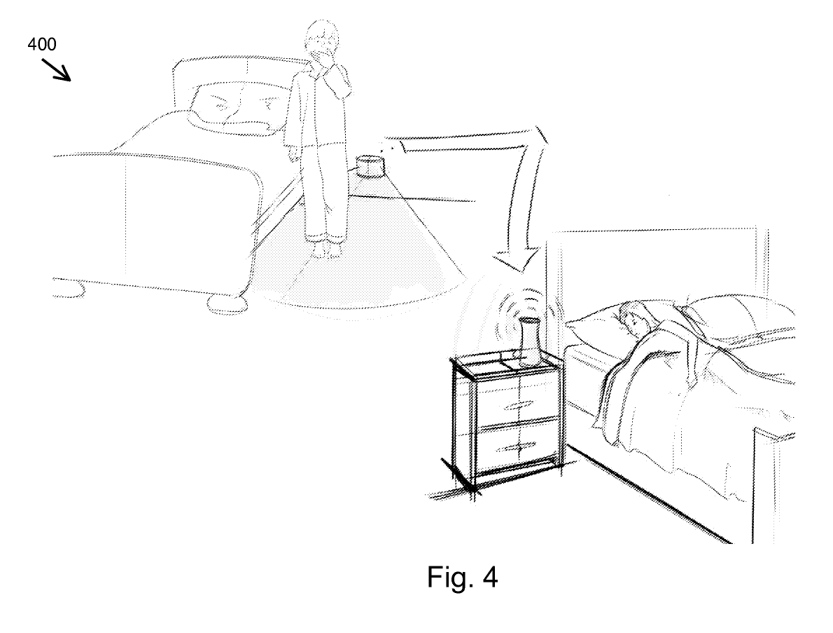

Referring to FIG. 4, a light communication system 400 may comprise a motion-activated night light triggering the illumination of a light or generation of an audible alert in a second location. A night light system utilizing a motion detector and wireless communication may provide interaction between an individual's behavior and an interested party wherein the night light in the individual's room when activated by the individual's activity signals to the corresponding night light in the interested party's room that illuminates and sounds a tone to notify the individual's activity. For example, a child may get up at night and trigger a motion-activated night light in their room. The activation of the night light may trigger, either through a direct wireless connection, through a direct corded connection, through a wireless connection mediated by a controller, or through a corded connection mediated by a controller, an activation of a light or generation of an audible alert in another room, such as a parent's bedroom, kitchen, or living room, to alert the parent that the child is awake. In any event, the motion-activated night light may also comprise a light-sensitive trigger. In embodiments, the motion-sensitive trigger and/or light-sensitive trigger may be switched off so that the night light may be persistently on.

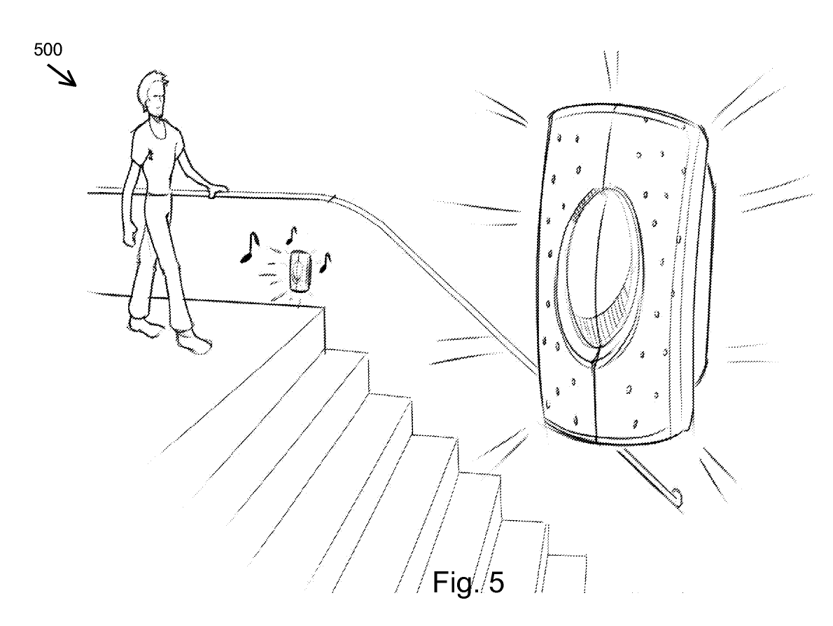

Referring to FIG. 5, an audio night alarm may signal hazards with a low level audio, such as if an individual has reached the top of a set of stairs, if they are near a sharp protruding corner of a dresser, about to run into a door sill, and the like. In an embodiment, an acoustic enunciator incorporates a motion detector and provides low level lighting and an acoustic alarm signaling hazardous situations around the house. In an embodiment, the audio night alarm may comprise an audible alert generator, a power source, a motion-sensitive trigger, and optionally, a light-sensitive trigger. When an individual passes the audio night alarm, the audio alarm may be triggered to play an alert. In embodiments, the audio night alarm may only play the alert if the light-sensitive trigger also senses a low level of light. In embodiments, the audio night alarm also comprises a light that is activated when the audio is activated. In embodiments, the motion-sensitive trigger and/or light-sensitive trigger may be switched off so that the audio alarm may be persistently on. In embodiments, the audio alarm may be controlled by a controller 202. The controller 202 may automatically activate the audio alarm under its control or it may activate motion- and or light-sensitive sensors connected to the audio alarm so that the sensors may trigger the alarm. In an embodiment, the light for the audio night alarm may be any light such as LED, incandescent, fluorescent, halogen, and the like.

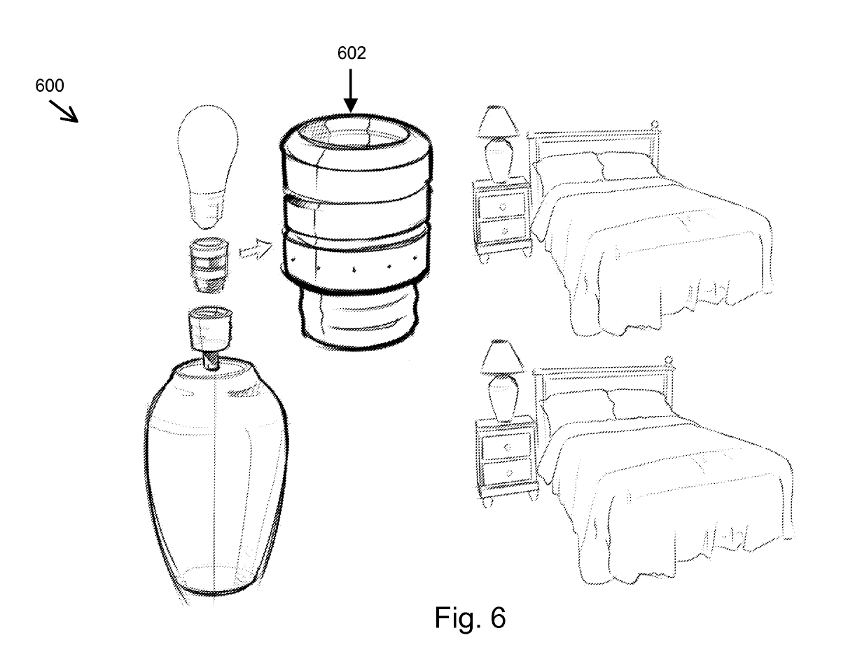

Referring to FIG. 6, a motion- and light-sensitive night light adaptor 602 may use an existing bulb combined with a motion sensor to create a low-level night light from standard bulb. The adaptor 602 may be threaded on both ends so that one end fits into a standard bulb socket and so that a bulb may screw into the other end. The adaptor 602 may have a motion sensor integrated in the adaptor 602 so that when an individual triggers the sensor, the bulb is illuminated to a lower level than its full power output. For example, if the bulb is a 60 Watt bulb, triggering the motion sensor may only illuminate the bulb to an output of 5 Watts. The motion sensor may only trigger an illumination if a light-sensitive trigger also senses a low light level. In embodiments, the motion-sensitive trigger and/or light-sensitive trigger may be turned off so that the night light may be persistently on. In embodiments, the adaptor 602 may be controlled by a controller. The controller may automatically activate the adaptor 602 night light under its control or it may activate motion- and or light-sensitive triggers connected to the lights so that the sensors may trigger the light. In embodiments, the adapter 602 contains a motion detector, an ambient light sensor and a voltage regulator that converts a standard bulb and socket from high output during day and twilight hours to a low-level night light after the sun has set. In an embodiment, the light for the night light adaptor 602 may be any light such as LED, incandescent, fluorescent, halogen, and the like.

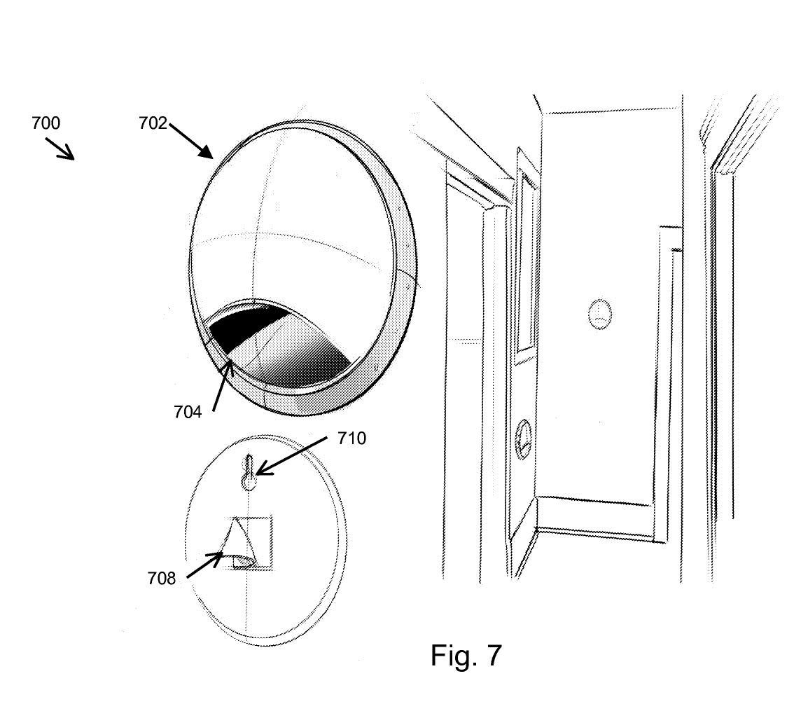

Referring to FIG. 7, a battery powered motion activated night light 702 may comprise a motion- and/or light-sensitive trigger 704. The light source used in the night light 702 may be Light Emitting Diode (LED), incandescent, fluorescent, halogen, and the like. For example, a self-contained LED battery powered night light with motion detection may capitalize on the inherent IR capability to create a virtual network among other night lights so that a nighttime traveler creates a path of light as they move around the house. The night light 702 may be placed anywhere along a path an individual may wish to navigate under conditions of low light. For example, the night light 702 may be hung on a wall using an adhesive strip 708 or a nail-keyhole 710 connection or inside the alarm clock 802. The night light 702 may be secured to a surface using any conventional securing or fastening means. In embodiments, the motion-sensitive trigger and/or light-sensitive trigger may be switched off so that the night light 702 may be persistently on. In embodiments, the night light 702 may be controlled by a controller. The controller may automatically activate the night light 702 under its control or it may activate motion- and or light-sensitive sensors connected to the light so that the sensors may trigger the light.

Referring to FIG. 8, an alarm clock 802 may comprise a sensor 804. In an embodiment the alarm clock 802 may be any type of clock. The sensor 804 may be motion-sensitive and/or light-sensitive. Examples of the sensor 804 may include an Infra Red (IR) based sensor, Ultra Violet (UV) based sensor, visible light based sensor, proximity based sensor, contact based sensor, vibration based sensor, or some other light or motion based sensor. The alarm clock 802 may be provided with a light source 808 for illumination. In an embodiment, the light source 808 may be integrated inside the alarm clock 802. The light source 808 may be activated upon sensing of light or motion by the sensor 804. Examples of the light source 808 may include LED, incandescent, fluorescent, halogen light source, and the like. Upon illumination, the light source 808 may help in navigation in low light and easy viewing of the time.

In an example, initially the alarm clock 802 may not be illuminated. The user may like to view time in the alarm clock 802 in darkness or low light conditions, such as during night or when there is absence of an ambient light source. As the user waves a hand in front of the alarm clock 802, the sensor 804 may detect the motion. In addition, the sensor 804 may also detect the absence of ambient light, indicating darkness in the room where the alarm clock 802 is located. As a result, the sensor 804 causes the light source 808 to be activated. The activated light source 808 illuminates the face of alarm clock 802. Therefore, the user may easily view the time in the alarm clock 802 in darkness. In embodiments, the light provided by the illuminated alarm clock 802 may be used for navigation in low light. In an embodiment, the light sensor within sensor 804 prevents illumination of the alarm clock 802 during the day.

In an embodiment, the light source 808 in the alarm clock 802 may shut down after a period of time. This period of time may range from few seconds to few minutes and may be pre-determined.

In an aspect of the invention, the alarm clock 802 may be associated with the controller 202. The controller may automatically illuminate the alarm clock 802 or it may activate the sensor 804 so that the light source 808 in the alarm clock 802 may be activated.

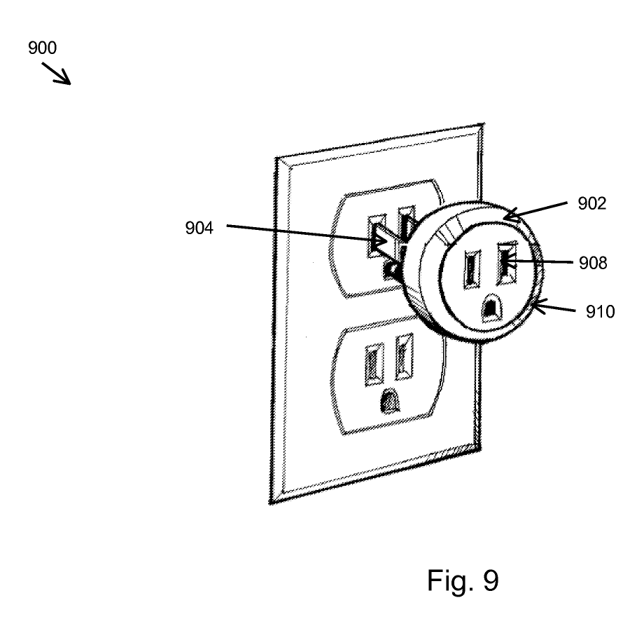

Referring to FIG. 9, an electrical plug 908 may be integrated with a small light 902, so as to provide the advantages of a night light and an electrical outlet together, to a user. The exemplary small light 902 may be associated with a standard electrical outlet 904 for illuminating dark and inaccessible areas that do not receive sufficient lighting. In an aspect of the invention, the small light 902 may be inserted into the standard electrical outlet 904. The light source for this small light 902 may be LED, incandescent, fluorescent, halogen, and the like. In other embodiments, the small light 902 source may be battery-operated, solar-operated, generator-operated, and some other type of light source. The standard electrical power outlet 904 may be an ordinary US-spec 110 VAC 60 Hz outlet or 220 VAC household or commercial outlets, and some other type of power outlets.

In an aspect of the invention, the electrical plug 908 may be a 2-prong or a 3-prong electrical plug. The electrical plug 908 may be a multiple-prong electrical plug 908. In other aspects of the invention, the small light 902 may include a plurality of electrical plugs 908. The shape and configuration of the electrical plug 908 may be similar or different to the standard electrical outlet 904, in which it is plugged. In other embodiments, the small light 902 may include electrical wiring to convert the 3-prong to the 2-prong electrical outlet, and vice versa.

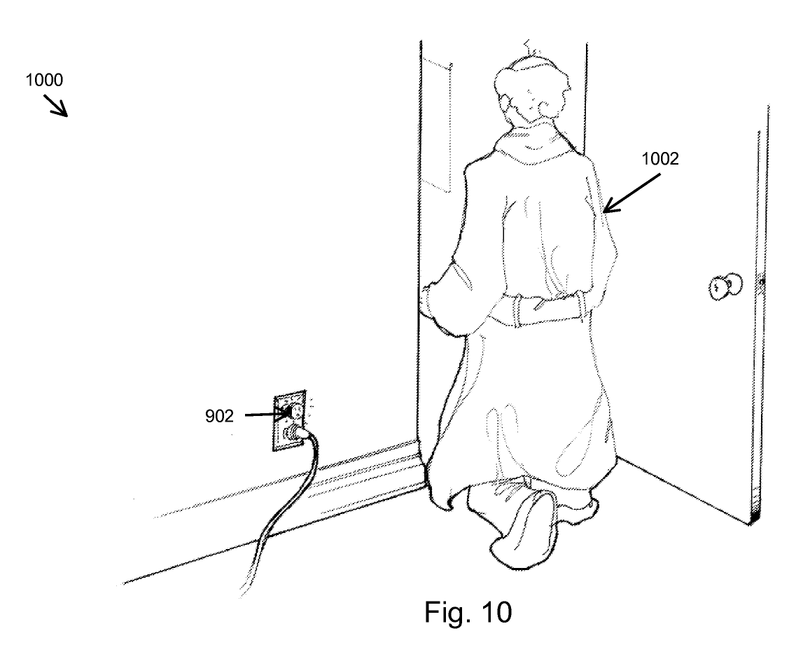

In embodiments, the small light 902 may be equipped with sensors. Examples of sensors may be an Infra Red (IR) based sensor, Ultra Violet (UV) based sensor, visible light based sensor, proximity based sensor, contact based sensor, vibration based sensor, and some other type of light or motion based sensors. Upon receiving an appropriate impetus, these sensors may activate the small light 902 to emit light 910, as shown in FIG. 9. In certain cases, light 910 may be emitted by a manual ON/OFF switch or a sound activated module. In an aspect of the invention, the sensors may be integrated with an audio alarm to signal hazard with a low level audio. For example, the hazard may be an inappropriate alignment of a device with the electrical outlet 904, when the user is trying to plug something into the electrical outlet 904. The activation of the small light 902, in response to a trigger is further explained in conjunction with FIG. 10. The trigger may be at least one of a motion, proximity, low levels of light, and some other type of triggers.

Referring to FIG. 10, the activated small light 902 plugged to the electrical outlet 904 in a passage such as a hallway is shown. The small light 902 may be equipped with a sensor. When a human or a passer-by 1002 comes in proximity of the sensors, the sensor may trigger the small light 902 and it may be activated to emit light 910. Therefore, the passage or the hallway may be sufficiently illuminated by the light 910 emitting from the small light 902. Consequently, the illuminated small light 902 may help in navigating comfortably and securely through dark or low-light areas. Further, the illuminated small light 902 may facilitate easy and secure plugging of any device into the electrical outlet 904. In embodiments, the small light 902 may be provided with the sound activated module. In another embodiment, the small light 902 may include alarms to alert regarding an intruder.

In an aspect of the invention, the lighting in the small light 902 may be associated with the controller 202. In embodiments, the small light 902 may be a part of a lighting system. The controller 202 may control any number of small lights 902 in the lighting system. The controller 202 may be the wireless remote control, the corded controller, or a combination thereof. The controller 202 may automatically illuminate the small light 902 under its control, or may activate motion- and or light sensitive triggers or sensors, so that the small light 902 may be activated.

What is claimed is:

1. A method for navigating in low light, comprising:
providing a light source integrated with a household object;
associating the light source with a power source;
associating the light source with a motion- and light-sensitive trigger; and
powering the light source when the motion-trigger senses motion and the light-trigger senses low light.

2. The method of claim 1, further comprising powering an additional light when the light-trigger senses motion and low light.

3. The method of claim 1, wherein the household object is at least one of a baseboard, a bath mat, an item of furniture, a stair, a picture frame, a door frame, a door knob, a clock, a railing, a passage, an edge of a bed, a rug, a bedside table, a planter, a plant, a mirror frame, a medicine cabinet, a towel rod, a shower rod, and a light bulb adaptor.

4. The method of claim 3, wherein the object is constructed as an electroluminescent panel.

5. The method of claim 1, wherein the motion- and light-sensitive trigger is housed in a light bulb adaptor configured to integrate a light bulb with the household object.

6. A method for navigating in low light, comprising:
providing a lighting system distributed about the perimeter of a household area in a position proximal to a baseboard of a room;
associating the lighting system with a power source;
associating the power source with a controller, wherein the controller controls at least a portion of the lighting system; and
using the controller to activate at least a portion of the lighting system corresponding to the portion of the area to be navigated.

7. The method of claim 6, wherein the lighting system is active.

8. The method of claim 6, wherein the lighting system is passive.

9. The method of claim 6, wherein the lighting system is a fiber optic cabling.

10. The method of claim 6, wherein the lighting system is associated with a sensor.

11. The method of claim 10, wherein the sensor is an acoustic sensor.

12. The method of claim 10, wherein the sensor is a light sensor.

13. The method of claim 6, wherein the lighting system is disposed on the baseboard of a room.

14. The method of claim 6, wherein the controller is at least one of a wireless controller, a corded controller, and a combination thereof.

15. The method of claim 6, wherein the lighting system comprises a plurality of lights.

16. The method of claim 15, wherein each of the plurality of lights may be controlled by the controller.

17. A method for navigating in low light, comprising:
providing an audible tone generator;
associating the tone generator with a power source;
associating the tone generator with a motion- and light-sensitive trigger; and
powering the tone generator when the motion-trigger senses motion and the light-trigger senses low light.

18. The method of claim 17, wherein the audible tone generator signals hazards.

19. The method of claim 18, wherein the hazard is a top of a set of stairs.

20. The method of claim 18, wherein the hazard is a sharp protruding corner.
